(19) United States
(12) Patent Application Publication
(10) Pub. No.: US 2025/0369904 A1
(43) Pub. Date: Dec. 4, 2025

(54) ANGLE RESOLVED WAVELENGTH DISPERSIVE SPECTROMETER

(71) Applicant: Sigray, Inc., Benicia, CA (US)

(72) Inventors: Wenbing Yun, Walnut Creek, CA (US); Benjamin Donald Stripe, Berkeley, CA (US)

(21) Appl. No.: 19/225,925

(22) Filed: Jun. 2, 2025

Related U.S. Application Data
(60) Provisional application No. 63/656,012, filed on Jun. 4, 2024.

(51) Int. Cl. G01N 23/2209; G01N 23/223

(52) U.S. Cl. CPC G01N 23/2209; G01N 23/223

(57) ABSTRACT

An apparatus includes a plurality of x-ray detection elements configured to receive and detect fluorescence x-rays emitted from a surface of an object being irradiated by an excitation beam. The plurality of x-ray detection elements includes at least a first x-ray detection element configured to receive and detect at least a first portion of the fluorescence x-rays emitted at a first emission angle relative to the surface with a first angular acceptance of less than 30 degrees. The plurality of x-ray detection elements further includes at least a second x-ray detection element configured to receive and detect at least a second portion of the fluorescence x-rays emitted at a second emission angle relative to the surface with a second angular acceptance less than 30 degrees, the second emission angle larger than the first emission angle by at least 0.5 degree.

### CLAIM OF PRIORITY

This application claims the benefit of priority to U.S. Provisional Appl. No. 63/656,012 filed Jun. 4, 2024, which is incorporated in its entirety by reference herein.

### BACKGROUND

### Field

This application relates generally to x-ray wavelength dispersive spectrometry systems.

### SUMMARY

In certain implementations, an apparatus comprises a plurality of x-ray detection elements configured to receive and detect fluorescence x-rays emitted from a surface of an object being irradiated by an excitation beam. The plurality of x-ray detection elements comprises at least a first x-ray detection element configured to receive and detect at least a first portion of the fluorescence x-rays emitted at a first emission angle relative to the surface with a first angular acceptance of less than 30 degrees. The plurality of x-ray detection elements further comprises at least a second x-ray detection element configured to receive and detect at least a second portion of the fluorescence x-rays emitted at a second emission angle relative to the surface with a second angular acceptance less than 30 degrees, the second emission angle larger than the first emission angle by at least 0.5 degree.

In certain implementations, an angle resolved wavelength dispersive spectrometer comprises at least one Bragg diffractor configured to receive and diffract a first set of fluorescence x-rays characteristic of and emitted by one or more atomic elements in an object. The at least one Bragg diffractor receives the first set of fluorescence x-rays emitted from the object at an emission angle of at least 0.001 degree from a surface of the object and over an emission angular range of at least 0.5 degree. The spectrometer further comprises a plurality of x-ray detection elements configured to receive and detect at least some of the diffracted x-rays from the at least one Bragg diffractor. The plurality of x-ray detection elements comprises at least a first x-ray detection element configured to receive and detect at least a first portion of the fluorescence x-rays diffracted by the at least one Bragg diffractor over a first diffraction angle relative to a surface normal of the at least one Bragg diffractor with a first angular acceptance less than 30 degrees. The plurality of x-ray detection elements further comprises at least a second x-ray detection element configured to receive and detect at least a second portion of the fluorescence x-rays diffracted by the at least one Bragg diffractor over a second diffraction angle relative to the surface normal of the at least one Bragg diffractor with a second angular acceptance less than 30 degrees, the second diffraction angle different from the first diffraction angle by a difference greater than 0.5 degree.

### BRIEF DESCRIPTION OF THE DRAWINGS

FIG. 1 schematically illustrates an example apparatus in accordance with certain implementations described herein.

FIG. 2 schematically illustrates an example apparatus comprising at least one Bragg diffractor in accordance with certain implementations described herein.

FIG. 3 schematically illustrates another example apparatus comprising at least one Bragg diffractor and at least one x-ray collimating optic in accordance with certain implementations described herein.

FIG. 4 schematically illustrates another example apparatus comprising a plurality of Bragg diffractors and at least one x-ray collimating optic in accordance with certain implementations described herein.

FIG. 5 schematically illustrates another example apparatus comprising a plurality of Bragg diffractors and a plurality of x-ray collimating optics in accordance with certain implementations described herein.

FIG. 6 schematically illustrates another example apparatus comprising a plurality of Bragg diffractors and a plurality of x-ray collimating optics in accordance with certain implementations described herein.

FIG. 7 schematically illustrates another example apparatus comprising at least one x-ray collimating optics having a functional reflective surface with periodic diffraction planes in accordance with certain implementations described herein.

### DETAILED DESCRIPTION

Certain implementations described herein provides an angle-resolved wavelength dispersive spectrometer configured to be used with an excitation beam irradiating an object being analyzed. The object can comprise a flat substrate, at least one or more thin layers of material on a substrate, or patterned periodic two-dimensional (2D) or three-dimensional (3D) structures having at least one dimension less than 10 microns (e.g., less than 1 micron; less than 0.1 micron; less than 0.01 micron) distributed over an area with at least one linear dimension greater than 0.5 micron (e.g., greater than 5 microns; greater than 40 microns; greater than 1000 microns). Examples of objects compatible with certain implementations described herein include but are not limited to: flat extended layered object (e.g., Si on insulator (SIO) with Si thickness from 1 nanometers to 20 nanometers); gate all around (GAA) nano transistors; other 3D structures. In certain implementations, the spectrometer can be used to monitor one or more manufacturing steps during a fabrication process. For example, the spectrometer can be used to evaluate an emission angle dependence of at least one fluorescence x-ray line of at least one atomic element of the object to obtain depth distribution information regarding the at least one atomic element in the object.

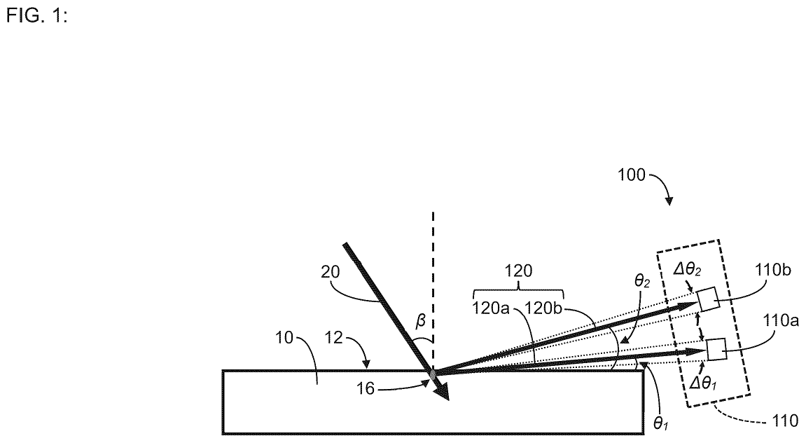

FIG. 1 schematically illustrates an example apparatus 100 in accordance with certain implementations described herein. The apparatus 100 comprises a plurality of x-ray detection elements 110 configured to receive and detect fluorescence x-rays 120 emitted from a surface 12 of an object 10 being irradiated by an excitation beam 20. The plurality of x-ray detection elements 110 comprises at least a first x-ray detection element 110a configured to receive and detect at least a first portion 120a of the fluorescence x-rays 120 at a first emission angle θ₁ relative to the surface 12 with a first angular acceptance Δθ₁ of less than 30 degrees (e.g., less than 10 degrees; less than 2 degrees; less than 0.5 degree; less than 0.01 degree) in a first emission plane defined by the surface normal of the surface 12 and the propagation direction of the first portion 120a of the fluorescence x-rays 120 received by the first x-ray detection element 110a. The plurality of x-ray detection elements 110 further comprises at least a second x-ray detection element 110b configured to receive and detect at least a second portion 120b of the fluorescence x-rays 120 at a second emission angle θ₂ relative to the surface 12 with a second angular acceptance Δθ₂ of less than 30 degrees (e.g., less than 10 degrees; less than 2 degrees; less than 0.5 degree; less than 0.01 degree) in a second emission plane defined by the surface normal of the surface 12 and the propagation direction of the second portion 120b of the fluorescence x-rays 120 received by the second x-ray detection element 110b. The second emission angle θ₂ is larger than the first emission angle θ₁ by at least 0.5 degree (e.g., at least 5 degrees; at least 15 degrees; at least 45 degrees). For example, as seen in FIG. 1, a first x-ray detection element 110a can have a first angular range in the first emission plane and having a first center (e.g., the first emission angle θ₁) and a second x-ray detection element 110b can have a second angular range in the second emission plane and having a second center (e.g., the second emission angle θ₂) with the second center larger than the first center. Although not shown in FIG. 1, the first x-ray detection element 110a can also have an angular range in a direction perpendicular to the first emission plane and the second x-ray detection element 110b can also have an angular range in a direction perpendicular to the second emission plane.

The excitation beam 20 (e.g., ionization beam) can comprise x-rays or charged particles (e.g., electrons) with sufficient energy to ionize atoms within a target region 16 at and below the surface 12, such that the ionized atoms generate fluorescence x-rays 120 that are characteristic of the atomic elements of the ionized atoms. The energy of the excitation beam 20 can be selected such that the excited atoms generate fluorescence x-rays 120 of at least one fluorescence x-ray line that is characteristic of at least one atomic element of interest, and the apparatus 100 can be configured to measure the fluorescence x-rays 120 of the at least one characteristic fluorescence x-ray line.

In certain implementations, the excitation beam 20 is collimated, focused, or diverging and the target region 16 in which the fluorescence x-rays 120 are generated extends from the surface 12 into the object 10. For example, the excitation beam 20 can comprise an excitation source (e.g. x-ray source) and a focusing optic configured to collect the x-rays or charged particles from the excitation source and to produce an excitation beam having a lateral dimension (e.g., in a direction substantially parallel to the plane defined by the excitation beam 20 and the surface normal of the surface 12; in a direction substantially perpendicular to the beam propagation direction) in a range of 0.5 micron to 100 microns. For example, the target region 16 can have a lateral size (e.g., in a direction substantially perpendicular to the plane defined by the excitation beam 20 and the surface normal of the surface 12; in a direction substantially parallel to the surface 12) at the surface 12 that is less than 1000 microns (e.g., less than 100 microns; less than 20 microns; less than 5 microns). For example, the excitation beam 20 can have a lateral spot size at and parallel to the surface 12 that is less than 100 microns (e.g., less than 30 microns; less than 10 microns).

In certain implementations, the excitation beam 20 comprises x-rays with energies less than 20 keV (e.g., less than 10 keV; less than 4 keV; less than 2 keV; less than 1 keV; less than 0.5 keV) which can have relatively short linear attenuation length (e.g., depth of the target region 16) to facilitate using the apparatus 100 for obtaining depth and/or lateral elemental/material information (e.g., structures of semiconductor devices with nanometer dimensions). The linear attenuation length of the excitation x-rays of the excitation beam 20 can be selected to provide between 2% and 50% attenuation from the production point of the x-rays to the surface 12 of the object 10.

In certain implementations, the excitation beam 20 comprises an x-ray ionization beam having a spot size of less than 100 microns at the surface 12 (e.g., less than 30 microns; less than 10 microns) and the energy of the excitation beam 20 can have an energy spectrum with less than 50% (e.g., less than 25%; less than 10%) of the x-rays having energies greater than the Si K-edge absorption energy (about 1.84 keV), which can be used to reduce (e.g., minimize) generation of Si Kα fluorescence x-rays in an object 10 comprising a Si substrate. In certain implementations, the excitation beam 20 comprises an electron ionization beam having a spot size of less than 20 microns at the surface 12 (e.g., less than 5 microns; less than 1 micron) with a maximum electron energy less than 30 kVp (e.g., less than 15 kVp; less than 10 kVp; less than 3 kVp). In certain implementations, the excitation beam 20 can be used to achieve a small spot analysis, to reduce (e.g., minimize) production of Bremsstrahlung radiation background, or a combination thereof.

In certain implementations, the plurality of x-ray detection elements 110 is a unitary structure (e.g., the first and second x-ray detection elements 110a,b are components of a single x-ray detector), while in certain other implementations, the plurality of x-ray detection elements 110 comprises two or more x-ray detectors structure (e.g., the first and second x-ray detection elements 110a,b are both components of the same x-ray detector; the first and second x-ray detection elements 110a,b are each a component of different x-ray detectors). In certain implementations, at least one x-ray detector element 110 is configured to collect fluorescence x-rays 120 emitted from the surface 12 of the object 10 irradiated by an excitation beam 20 over an acceptance angle perpendicular to the first emission angle or the second emission angle, the acceptance angle greater than 1 degree (e.g., greater than 10 degrees; greater than 30 degrees).

In certain implementations, one or more individual x-ray detection elements of the plurality of x-ray detection elements 110 (e.g., the first and second x-ray detection elements 110a,b) are selected from the group consisting of: silicon drift detector (SDD), proportion counter, ionization chamber, scintillator counter. In certain implementations, one or more individual x-ray detection elements of the plurality of x-ray detection elements 110 (e.g., the first and second x-ray detection elements 110a,b) comprises at least two pixels of a pixel array detector (e.g., 1D or 2D CCD, CMOS, or photon counting detector). In certain implementations, the plurality of x-ray detection elements 110 comprises n x-ray detection elements, with n in a range of greater than two (e.g., greater than 4; greater than 10; greater than 100; greater than 1000) x-ray detection elements of a pixel array detector, and the pixel size is in a range of 2 microns to 500 microns (e.g., in a range of 2 microns to 250 microns). The plurality of x-ray detector elements 110 can be configured such that an angular acceptance of individual x-ray detection elements 110a,b, . . . ,n of the plurality of x-ray detection elements 110 (e.g., the first angular acceptance Δθ₁; the second angular acceptance Δθ₂) of at least one characteristic x-ray line from the target region 16 is less than 30 degrees (e.g., less than 10 degrees; less than 2 degrees; less than 0.5 degree; less than 0.01 degree) in an emission plane defined by the surface normal of the surface 12 and the propagation direction of the fluorescence x-rays 120 received by the plurality of x-ray detection elements 110 and/or in a plane substantially perpendicular to the emission plane.

Since the first portion 120a of the fluorescence x-rays 120 is emitted from the surface 12 with the first emission angle θ₁ that is smaller than the second emission angle θ₂ of the second portion 120b of the fluorescence x-rays 120, the first portion 120a of the fluorescence x-rays 120 undergoes more absorption by intervening material of the object 10 prior to being emitted from the surface 12 than does the second portion 120b of the fluorescence x-rays 120. As a result, first detection signals generated by the first x-ray detection element 110a in response to the first portion 120a of the fluorescence x-rays 120 and second detection signals generated by the second x-ray detection element 110b in response to the second portion 120b of the fluorescence x-rays 120 can provide depth distribution information of one or more atomic elements in the object 10.

In certain implementations, the excitation beam 20 has an incidence angle β relative to a surface normal of the surface 12, and the incidence angle β can be in a range of 0.01 degrees to 90 degrees (e.g., in a range of 0.01 degrees to 30 degrees; in a range of 0.01 degrees to 45 degrees; in a range of 0.01 degrees to 60 degrees; in a range of 30 degrees to 45 degrees; in a range of 45 degrees to 60 degrees; in a range of 60 degrees to 90 degrees). By having the incidence angle β closer to 90 degrees, the depth distribution of the ionized atoms can be maximized closer to the surface 12. In certain implementations, the excitation beam 20 and the plurality of x-ray detection elements 11 are fixed relative to one another during a measurement.

In certain implementations, the first emission angle θ₁ is at least one degree (e.g., at least 5 degrees). In certain implementations, the second emission angle θ₂ is greater than first emission angle θ₁ by at least 1 degrees (e.g., by at least 5 degrees; by at least 15 degrees; by at least 45 degrees). In certain implementations, the reciprocal of the first emission angle θ₁ minus the reciprocal of the second emission angle θ₂ is greater than 5% of the reciprocal of the first emission angle θ₁ (sin θ₁·[(1/sinθ₁)−(1/sinθ₂)]) is greater than 2% (e.g., greater than 5%; greater than 10%).

In certain implementations, at least one of the first x-ray detection element 110a and the second x-ray detection element 110b is configured to detect fluorescence x-rays 120 propagating in a plane defined by the excitation beam 20 and the surface normal of the surface 12, while in certain other implementations, at least one of the first x-ray detection element 110a and the second x-ray detection element 110b is configured to detect fluorescence x-rays 120 not propagating in the plane defined by the excitation beam 20 and the surface normal of the surface 12. In certain implementations, the first x-ray detection element 110a and the second x-ray detection element 110b are configured to detect fluorescence x-rays 120 propagating in the same plane as one another (e.g., a plane substantially perpendicular to the surface 12), while in certain other implementations, the first x-ray detection element 110a and the second x-ray detection clement 110b are configured to detect fluorescence x-rays 120 propagating in different planes from one another (e.g., the first portion 120a of the fluorescence x-rays 120 are propagating in a first plane substantially perpendicular to the surface 12 and the second portion 120b of the fluorescence x-rays 120 are propagating in a second plane that is also substantially perpendicular to the surface 12). For example, the first portion 120a can have a first azimuthal angle relative to the plane defined by the excitation beam 20 and the surface normal of the surface 12 and the second portion 120b can have a second azimuthal angle relative to the plane defined by the excitation beam 20 and the surface normal of the surface 12, the second azimuthal angle different from the first azimuthal angle.

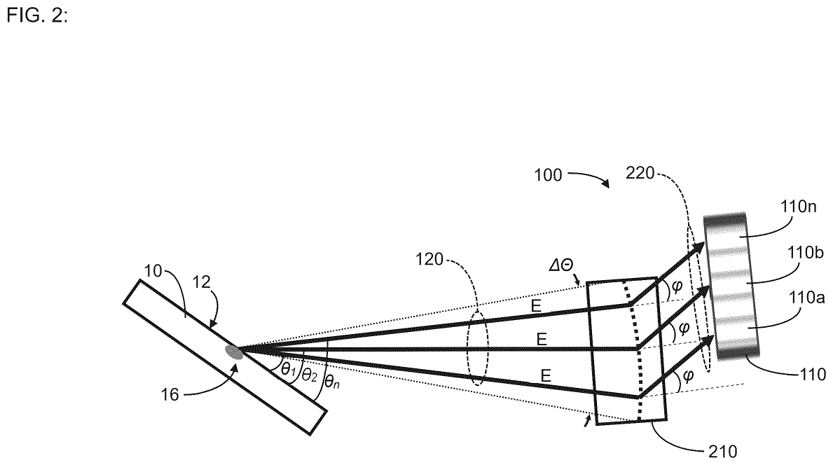

FIGS. 2-7 schematically illustrate various example apparatus 100 comprising at least one Bragg diffractor 210 in accordance with certain implementations described herein. The example apparatus 100 of FIGS. 2-7 can be used as an angle resolved wavelength dispersive spectrometer. In certain implementations, the spectrometer is configured to detect an emission angle dependence of at least one characteristic fluorescence x-ray line emitted by at least one atomic element of the object to obtain depth distribution information of the at least one atomic element in the object 10. FIGS. 2-7 show the object 10, surface 12, and target region 16, but excludes the excitation beam 20 for clarity.

In FIG. 2, a side view of the object 10 is shown (e.g., as in FIG. 1) but a top view of the at least one Bragg diffractor 210 is shown. The at least one Bragg diffractor 210 is configured to receive and diffract fluorescence x-rays 120 emitted from the object 10, the fluorescence x-rays 120 comprising at least one fluorescence x-ray line (e.g., one x-ray line; two x-ray lines; more than two x-ray lines) that is characteristic of and emitted by at least one atomic element in the object 10 over an emission angular range ΔΘ of at least 0.5 degree (e.g., at least 5 degrees; at least 50 degrees) with respect to the surface 12 of the object 10 with emission angles θ₁, θ₂, . . . θ_{,} of at least 0.001 degree (e.g., at least 1 degree; at least 5 degrees).

In certain implementations, the at least one Bragg diffractor 210 comprises a flat diffractor, while in certain other implementations, the at least one Bragg diffractor 210 comprises a curved diffractor (e.g., cylindrically bent or spherically bent). The at least one Bragg diffractor 210 can comprise a single crystal (e.g., LiF, Si, Ge, ATP), a mosaic crystal (e.g., HAPG, HOPG), or a synthetic multilayer diffractor, the at least one Bragg diffractor 210 having a distance between parallel planes corresponding to an energy of the at least one x-ray line to be diffracted. The at least one Bragg diffractor 210 can be selected according to the energy of the at least one characteristic fluorescence x-ray line to be measured. In certain implementations in which two or more Bragg diffractors 210 are used (e.g., at least one first Bragg diffractor 210a and at least one second Bragg diffractor 210b), individual Bragg diffractors can be single crystals, mosaic crystals, multilayers, or combinations thereof. In certain implementations, the at least one Bragg diffractor 210 comprises at least one multilayer monochromator on top of a single crystal (e.g., a Ge crystal) or a mosaic crystal (e.g., a HAPG crystal with or without a substrate) configured to diffract x-rays of two or more different energies.

In certain implementations in which the at least one Bragg diffractor 210 comprises multiple Bragg diffractors 210 (e.g., at least one first Bragg diffractor 210a and at least one second Bragg diffractor 210b), two or more of the Bragg diffractors 210 can be configured such that the diffracted at least one fluorescence x-ray line is directed toward the same x-ray detector elements 110. In certain implementations, the multiple Bragg diffractors 210 are in close proximity to one another. For example, adjacent first and second Bragg diffractors 210a,b can be within a distance less than 50 mm (e.g., less than 30 mm; less than 10 mm; less than 3 mm) of one another. In certain implementations, the multiple Bragg diffractors 210 are configured to increase the collection efficiency of the at least one fluorescence x-ray line and/or to simultaneously detect more fluorescence x-ray lines.

The apparatus 100 of FIG. 2 further comprises the plurality of x-ray detection elements 110 (e.g., first and second x-ray detection elements 110a,b), individual x-ray detection elements 110 of the plurality of x-ray detection elements 110 configured to receive respective portions of the fluorescence x-rays 120 diffracted by the at least one Bragg diffractor 210 (e.g., respective portions of the diffracted fluorescence x-rays 220 of at least one fluorescence x-ray line). The fluorescence x-rays 120 emitted from the target region 16 propagate with at least two different emission angles (e.g., first emission angle θ₁; second emission angle θ₂; more generally, n^{th} emission angle θₙ), and are diffracted by the at least one Bragg diffractor 210. Individual x-ray detection elements 110a,b, . . . , n of the plurality of x-ray detection elements 110 can have an angular acceptance (e.g., in a diffraction plane of the at least one Bragg diffractor 210 and/or in a plane substantially perpendicular to the diffraction plane) of less than 30 degrees (e.g., less than 10 degrees; less than 2 degrees; less than 0.5 degree; less than 0.01 degree).

As discussed herein with regard to FIG. 1, one or more individual x-ray detection elements 110a,b, . . . ,n of the plurality of x-ray detection elements 110 (e.g., the first and second x-ray detection elements 110a,b) are selected from the group consisting of: silicon drift detector (SDD), proportion counter, ionization chamber, scintillator counter. In certain implementations, one or more individual x-ray detection elements of the plurality of x-ray detection elements 110 (e.g., the first and second x-ray detection elements 110a,b) comprises at least two pixels of a pixel array detector (e.g., 1D or 2D CCD, CMOS, or photon counting detector). In certain implementations, the plurality of x-ray detection elements 110 comprises n x-ray detection elements, with n in a range of greater than two (e.g., greater than 4; greater than 10; greater than 100; greater than 1000) x-ray detection elements of a pixel array detector, and the pixel size is in a range of 2 microns to 500 microns (e.g., in a range of 2 microns to 250 microns). The plurality of x-ray detector elements 110 can be configured such that an angular acceptance of individual x-ray detection elements 110a,b, . . . ,n of the plurality of x-ray detection elements 110 (e.g., the first angular acceptance Δθ₁; the second angular acceptance Δθ₂) of at least one characteristic x-ray line from the target region 16 is less than 30 degrees (e.g., less than 10 degrees; less than 2 degrees; less than 0.5 degree; less than 0.01 degree) in an emission plane defined by the surface normal of the surface 12 and the propagation direction of the fluorescence x-rays 120 received by the plurality of x-ray detection elements 110 and/or in a plane substantially perpendicular to the emission plane.

The object 10, at least one Bragg diffractor 210, and the plurality of x-ray detection elements 110 are configured such that the at least one fluorescence x-ray line in the portions of the fluorescence x-rays 120 (e.g., having the same energy E) propagating with different emission angles are diffracted by the at least one Bragg diffractor 210 (e.g., by the same diffraction angle φ) to respective x-ray detection elements 110a,b, . . . n of the plurality of x-ray detection elements 110. The footprint of the equal Bragg angles is shown as a dotted line across the at least one Bragg diffractor 210 in FIG. 2. In certain implementations, the at least one Bragg diffractor 210 is configured to simultaneously receive and diffract fluorescence x-rays 120 of at least one characteristic fluorescence x-ray line (e.g., one x-ray line; two x-ray lines; more than two x-ray lines) over an angular range ΔΘ of at least 0.5 degree (e.g., at least 5 degrees; at least 50 degrees) in both the emission plane (e.g., defined by the surface normal of the surface 12 and the propagation direction of the fluorescence x-rays 120 received by the at least one Bragg diffractor 210) and/or in a direction substantially perpendicular to the emission plane. The at least two x-ray detection elements 110 are configured to receive at least a portion of the diffracted fluorescence x-rays 220 of the at least one fluorescence x-ray line from the at least one Bragg diffractor 210, with individual x-ray detection elements 110 having an angular acceptance (e.g., in a diffraction plane defined by the fluorescence x-rays 120 from the target region 12 incident to the at least one Bragg diffractor 210 and the diffracted fluorescence x-rays 220 and/or in a plane substantially perpendicular to the diffraction plane) with an angular acceptance smaller than 30 degrees (e.g., smaller than 10 degrees; smaller than 2 degrees; smaller than 0.5 degree; smaller than 0.01 degree). The apparatus 100 can be configured to use the angular dependent fluorescence x-rays 120 to obtain depth and lateral distribution information of one or more atomic elements in the object 10.

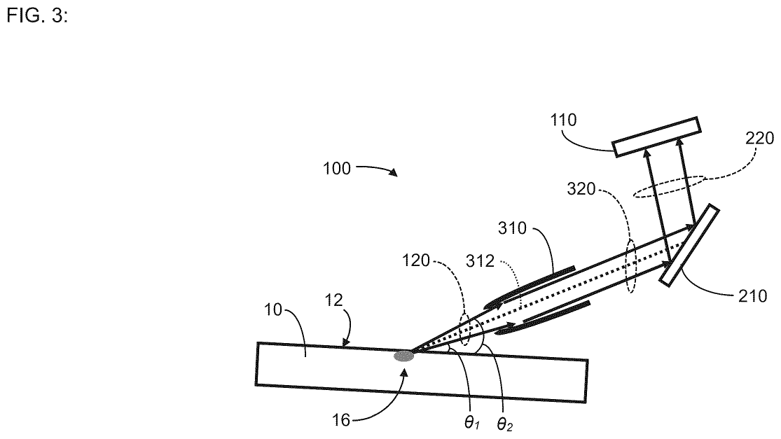

FIG. 3 schematically illustrates another example apparatus 100 (e.g., angle resolved wavelength dispersive spectrometer) in accordance with certain implementations described herein. The apparatus 100 of FIG. 3 comprises at least one x-ray collimating optic 310 configured to receive and collimate the fluorescence x-rays 120 of at least one fluorescence x-ray line (e.g., one x-ray line; two x-ray lines; more than two x-ray lines) characteristic of and emitted by one or more atomic elements in the object 10. The at least one x-ray collimating optic 310 has an angular range of at least 0.5 degree (e.g., at least 5 degrees; at least 20 degrees) with respect to the surface 12 of the object 10 in the emission plane, with a minimum emission angle of at least 0.001 degree (e.g., at least 1 degree; at least 5 degrees; at least 30 degrees).

In certain implementations, the at least one x-ray collimating optic 310 comprises a mirror optic with a reflective surface portion having a paraboloidal shape or a Wolter optic with an infinity image conjugate (e.g., a paraboloidal surface with cylindrical surface, a polycapillary optic, or a combination thereof). In certain implementations, the mirror optic surface comprises a coating comprising a high atomic mass density material (e.g., to increase the critical angle and solid angle of collection of characteristic x-rays) or a multilayer coating with layer spacings graded along an optical axis 312 of the at least one x-ray collimating optic 310 and/or along a depth (e.g., to increase x-ray collection efficiency of predetermined characteristic x-rays).

The output of the at least one x-ray collimating optic 310 can be a beam of collimated fluorescence x-rays 320 with an angular divergence of less than 3 degrees (e.g., less than 1 degree; less than 0.1 degree). The collimated fluorescence x-rays 320 can be incident on at least one Bragg diffractor 210 (e.g., a flat Bragg diffractor) configured to diffract, according to the Bragg law, the collimated fluorescence x-rays 320 having at least one of the at least one characteristic x-ray line from the x-ray collimating optic 310. In certain implementations, the at least one Bragg diffractor 210 can comprise multilayers of different spacings and materials deposited on a flat substrate, the multilayers configured to concurrently diffract two or more preselected characteristic x-ray lines in the beam of collimated fluorescence x-rays 320. For example, an inner area of a multilayer Bragg diffractor 210 can correspond to an inner region of the beam of collimated fluorescence x-rays 320 and can be configured to diffract a first characteristic x-ray line while an outer (e.g., annular) area of the multilayer Bragg diffractor 210 can correspond to an outer region of the beam of collimated fluorescence x-rays 320 and can be configured to diffract a second characteristic x-ray line different from the first characteristic x-ray line.

At least a portion of the diffracted fluorescence x-rays 220 is incident on the plurality of x-ray detection elements 110 configured to detect at least one diffracted fluorescence x-ray line emitted from the target region 16 with at least two different emission angles (e.g., first and second emission angle θ₁, θ₂ shown in FIG. 3) with an angular separation between the emission angles of less than 20 degrees (e.g., less than 5 degrees; less than 2 degrees; less than 0.5 degree; less than 0.01 degree). The angular dependence of the fluorescence x-rays 120 in the emission plane can be used to obtain depth distribution information of the one or more atomic elements in the object 10.

In certain implementations, the apparatus 100 of FIG. 3 is configured to simultaneously receive and diffract the fluorescence x-rays 120 emitted from the target region 16 with at least two different emission angles (e.g., at least 0.001 degree) and having at least one characteristic fluorescence x-ray line (e.g., one x-ray line; two x-ray lines; more than two x-ray lines). The diffracted fluorescence x-rays 320 are detected by the plurality of x-ray detection elements 110 over an angular range of at least 0.5 degree (e.g., at least 5 degrees; at least 50 degrees) in both the diffraction plane and a plane substantially perpendicular to the diffraction plane with the plurality of x-ray detection elements 110 configured to receive at least a portion of the diffracted fluorescence x-rays 220 having the at least one fluorescence x-ray line with an angular acceptance smaller than 30 degrees (e.g., smaller than 10 degrees; smaller than 2 degrees; smaller than 0.5 degree; smaller than 0.01 degree). The angular dependent fluorescence x-rays 120 can be used to obtain depth and lateral distribution information of one or more atomic elements in the object 10.

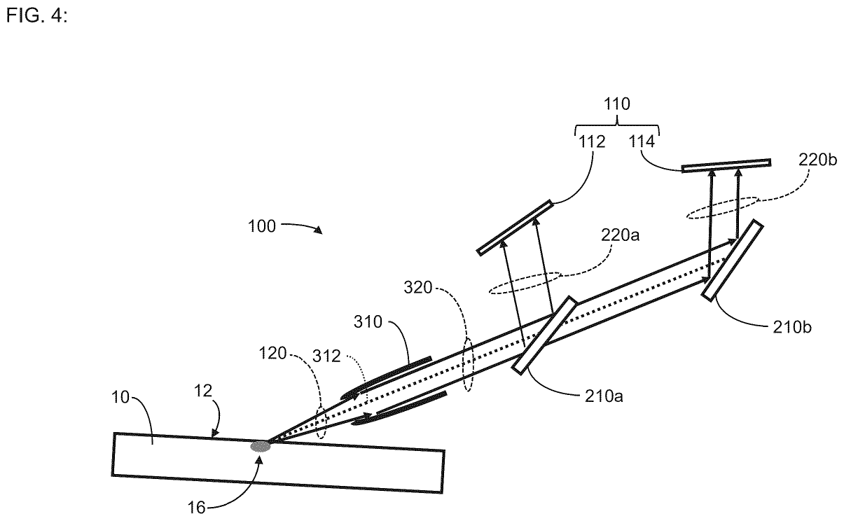

FIG. 4 schematically illustrates another example apparatus 100 (e.g., angle resolved wavelength dispersive spectrometer) in accordance with certain implementations described herein. The apparatus 100 of FIG. 4 includes the features of the apparatus 100 of FIG. 3 and additionally comprises at least one second Bragg diffractor 210b configured to receive a portion of the beam of collimated fluorescence x-rays 320 that are transmitted through the first Bragg diffractor 210a. The plurality of x-ray detection elements 110 comprises a first set 112 of x-ray detection elements 110 and a second set 114 of x-ray detection elements 110, each of the first set 112 and the second set 114 comprising multiple x-ray detection elements 110. While FIG. 4 shows the first set 112 and the second set 114 separate from one another (e.g., two individual x-ray detectors), in certain other implementations, the first set 112 and the second set 114 are parts of a unitary structure (e.g., a single x-ray detector). The at least one first Bragg diffractor 210a is configured to diffract at least a first portion 220a of the collimated fluorescence x-rays 320 to the first set 112 of x-ray detection elements 110 and the at least one second Bragg diffractor 210b is configured to diffract at least a second portion 220b of the collimated fluorescence x-rays 320 to the second set 114 of x-ray detection elements 110. For example, the first Bragg diffractor 210a can comprise a substantially flat multilayer Bragg diffractor with a thin substrate (e.g., Si₃N₄ substrate) and the second Bragg diffractor 210b can comprise a substantially flat single crystal or mosaic crystal.

In certain implementations, the at least one second Bragg diffractor 210b is close to the at least one first Bragg diffractor 210a (e.g., within a distance less than 300 mm; less than 100 mm; less than 30 mm). In certain implementations, the first portion 220a and the second portion 220b comprise the same characteristic fluorescence x-ray line, while in certain other implementations, the first portion 220a and the second portion 220b comprise different characteristic fluorescence x-ray lines. Certain such implementations utilizing at least one second Bragg diffractor 210b can increase the collection efficiency of the characteristic at least one x-ray line and/or can detect more characteristic x-ray lines simultaneously.

In certain implementations, the first set 112 of x-ray detector elements 110 and/or the second set 114 of x-ray detector elements 110 is selected from the group consisting of: silicon drift detector (SDD), proportional counter, ionization chamber, scintillator counter. In certain implementations, the first set 112 of x-ray detector elements 110 and/or the second set 114 of x-ray detector elements 110 comprises at least two pixels of a pixel array detector (e.g., 1D or 2D CCD, CMOS, or photon counting detector). In certain implementations, the number of x-ray detection elements 110 of the first set 112 of x-ray detector elements 110 and/or the second set 114 of x-ray detector elements 110 is greater than 4 (e.g., greater than 10; greater than 100; greater than 1000) and the pixel size is in a range of 2 microns to 500 microns. The first set 112 of x-ray detector elements 110 and/or the second set 114 of x-ray detector elements 110 can be configured to have an angular acceptance of characteristic at least one x-ray line that is smaller than 30 degrees (e.g., smaller than 10 degrees; smaller than 2 degrees; smaller than 0.5 degree; smaller than 0.01 degree).

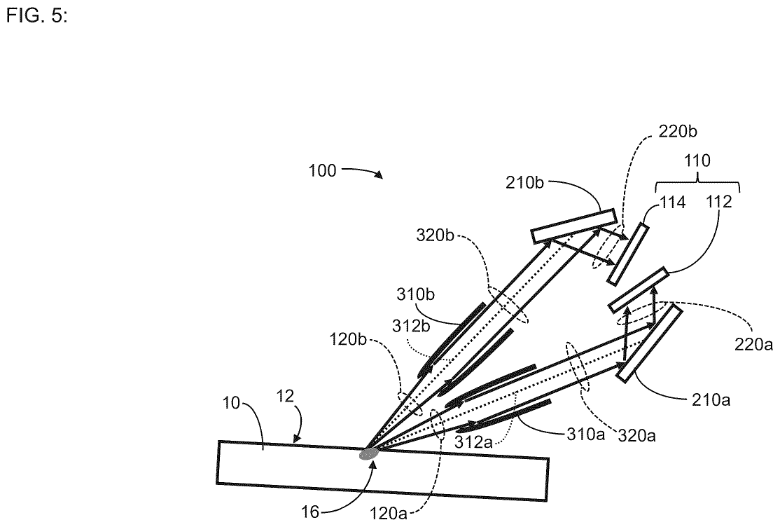

FIG. 5 schematically illustrates another example apparatus 100 (e.g., angle resolved wavelength dispersive spectrometer) in accordance with certain implementations described herein. The apparatus 100 of FIG. 5 can be considered to be a plurality of parallel beam wavelength dispersive x-ray spectrometers (see, e.g., FIG. 4) configured to simultaneously receive fluorescence x-rays 120 emitted from the target region 16 of the object 10. The plurality of parallel beam wavelength dispersive spectrometers are configured to receive characteristic x-rays from substantially the same target region 16 of the object 10 with at least two of the parallel beam wavelength dispersive spectrometers configured at different emission angles (see, e.g., FIG. 5). The angular dependence of the fluorescent x-rays 120a,b in the emission plane can be used to obtain depth distribution information of the one or more atomic elements in the object 10.

As shown in FIG. 5, the at least one x-ray collimating optic 310 comprises a first x-ray collimating optic 310a having a first optical axis 312a and a second x-ray collimating optic 310b having a second optical axis 312b. The first x-ray collimating optic 310a is configured to receive and collimate a first portion 120a of the fluorescence x-rays 120 emitted from the surface 12 and the second x-ray collimating optic 310b is configured to receive and collimate a second portion 120b of the fluorescence x-rays 120 emitted from the surface 12. The first portion 120a can comprise at least one first characteristic fluorescence x-ray line emitted by one or more atomic elements in the object 10 and the second portion 120b can comprise at least one second characteristic fluorescence x-ray line emitted by one or more atomic elements in the object 10.

The first x-ray collimating optic 310a and/or the second x-ray collimating optic 310b can receive the respective first and second portions 120a,b of the fluorescence x-rays 120 in an angular range of at least 0.5 degree (e.g., at least 5 degrees; at least 50 degrees) in a respective emission plane with an emission angle of at least 0.001 degree (e.g., at least 1 degree; at least 5 degrees). Each of the first and second x-ray collimating optic 310a,b can produce a corresponding beam of collimated fluorescence x-rays 320a,b with an angular divergence less than 3 degrees (e.g., less than 1 degree; less than 0.1 degree).

The collimated fluorescence x-rays 320a can be incident on a first Bragg diffractor 210a (e.g., a flat Bragg diffractor) configured to diffract, according to the Bragg law, the collimated fluorescence x-rays 320a having at least one of the at least one characteristic x-ray line from the x-ray collimating optic 310a. The collimated fluorescence x-rays 320b can be incident on a second Bragg diffractor 210b (e.g., a flat Bragg diffractor) configured to diffract, according to the Bragg law, the collimated fluorescence x-rays 320b having at least one of the at least one characteristic x-ray line from the x-ray collimating optic 310b. The at least one first Bragg diffractor 210a is configured to diffract at least a first portion 220a of the collimated fluorescence x-rays 320a to the first set 112 of x-ray detection elements 110 and the at least one second Bragg diffractor 210b is configured to diffract at least a second portion 220b of the collimated fluorescence x-rays 320b to the second set 114 of x-ray detection elements 110.

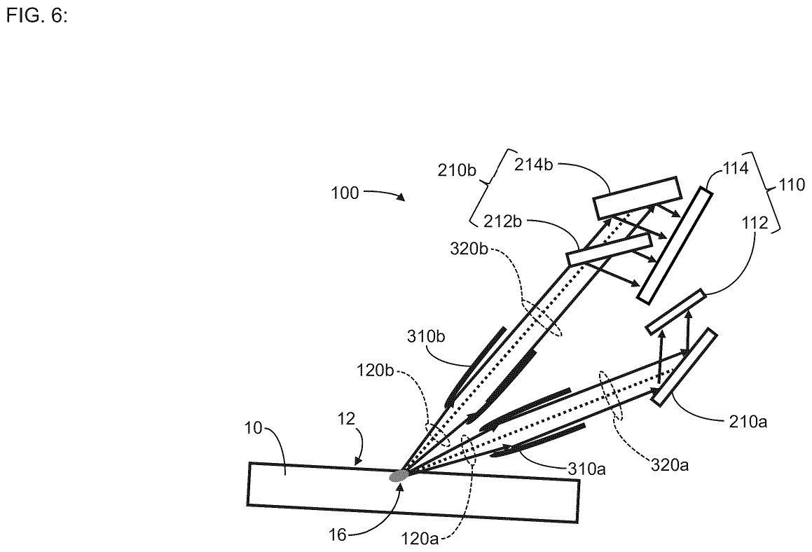

FIG. 6 schematically illustrates another example apparatus 100 (e.g., angle resolved wavelength dispersive spectrometer) in accordance with certain implementations described herein. As discussed with regard to FIG. 5, the apparatus 100 of FIG. 6 can be considered to be a plurality of parallel beam wavelength dispersive x-ray spectrometers configured to simultaneously receive fluorescence x-rays 120 emitted from the target region 16 of the object 10.

As shown in FIG. 6, the at least one second Bragg diffractor 210b comprises two Bragg diffractors 212b,214b, the Bragg diffractor 214b configured to receive a portion of the beam of collimated fluorescence x-rays 320b that are transmitted through the Bragg diffractor 212b. The Bragg diffractor 212b is configured to diffract at least a first portion of the collimated fluorescence x-rays 320b to the second set 114 of x-ray detection elements 110 and the Bragg diffractor 214b is configured to diffract at least a second portion of the collimated fluorescence x-rays 320b to the second set 114 of x-ray detection elements 110. While FIG. 6 shows the Bragg diffractors 212b,214b diffracting the respective portions of the collimated fluorescence x-rays 320b to the same set 114 of x-ray detection elements 110, in certain other implementations, the Bragg diffractors 212b,214b can diffract the respective portions of the collimated fluorescence x-rays 320b to separate sets of x-ray detection elements 110. In certain implementations, the Bragg diffractor 214b is placed in close proximity to the Bragg diffractor 212b (e.g., within a distance less than 30 mm; less than 10 mm; less than 3 mm). In certain implementations, the Bragg diffractors 212b,214b either increase the collection efficiency of the at least one fluorescence x-ray line and/or allow more fluorescence x-ray lines to be detected simultaneously.

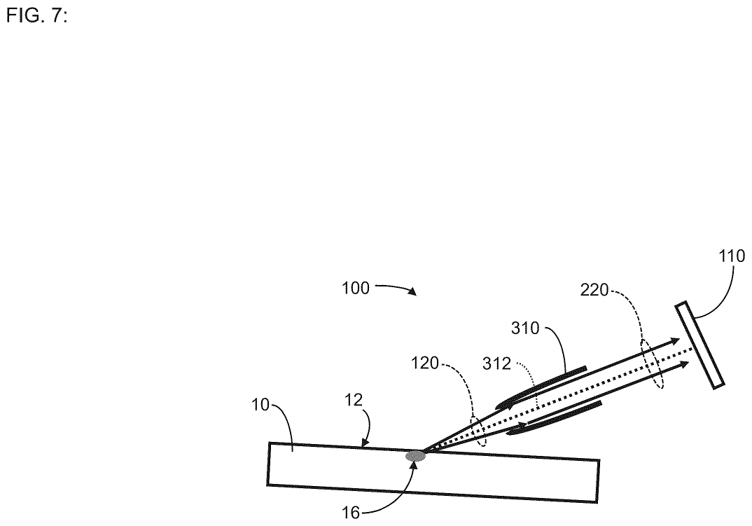

FIG. 7 schematically illustrates another example apparatus 100 (e.g., angle resolved wavelength dispersive spectrometer) in accordance with certain implementations described herein. In the apparatus 100 of FIG. 7, the functionality of the at least one Bragg diffractor 210 is provided by the at least one x-ray optic 310. For example, the at least one x-ray optic 310 can comprise a functional reflective surface having a cylindrically symmetric shape about the optical axis 312 and comprising periodic diffraction planes (e.g., single crystal, mosaic crystals, or multilayers) configured to receive and diffract fluorescence x-rays 120 having at least one characteristic fluorescence x-ray line emitted from the target region 16 by one or more atomic elements in the object 10. In certain implementations, the diffraction planes (e.g., multilayers) have the same d-spacings with a number of layer pairs greater than 20 (e.g., greater than 50). In certain implementations, the multilayers have variable d-spacings (e.g., graded multilayers; d-spacings that vary along and/or perpendicular to the x-ray propagation direction). In certain implementations, at least two different portions of the functional surface comprise multilayers and mosaic crystals.

The at least one x-ray optic 310 can receive fluorescence x-rays 120 over an angular range of at least 0.5 degree (e.g., at least 5 degrees; at least 20 degrees) in the emission plane with an emission angle of at least 0.001 degree (e.g., at least 1 degree; at least 5 degrees). In certain implementations, at least a portion of the functional surface is curved in a plane containing the optical axis 312 of the cylindrically symmetric shape (e.g., parabolic; elliptical). At least a portion of the beam of collimated and diffracted fluorescence x-rays 220 is incident on the plurality of x-ray detection elements 110 configured to detect diffracted fluorescence x-ray line(s) over two different emission angles with an angular acceptance smaller than 20 degrees (e.g., smaller than 10 degrees; smaller than 2 degrees; smaller than 0.5 degree; smaller than 0.01 degree). In certain implementations, the apparatus 100 of FIG. 7 can be used to evaluate an emission angle dependence of the fluorescence x-rays 120 which can be used to obtain depth distribution information of the one or more atomic elements in the object 10.

In certain implementations, detection signals from the plurality of x-ray detection elements 110 are used to obtain depth distribution information of the one or more atomic elements in the object 10. For example, the apparatus 100 can comprise circuitry configured to receive detection signals from the plurality of x-ray detection elements 110 and to calculate the depth distribution information of the one or more atomic elements in the object 10. The circuitry can comprise one or more microprocessors (e.g., application-specific integrated circuits (ASICs); digital signal processors; microelectronic circuitry; microcontroller core; at least one generalized integrated circuit programmed by software with computer executable instructions;) and at least one storage device (e.g., at least one tangible or non-transitory computer readable storage medium; non-volatile memory; read only memory; random access memory; flash memory) configured to store information (e.g., data; commands) accessed by the one or more microprocessors during operation of the apparatus 100. For example, the at least one storage device can be encoded with software (e.g., a computer program downloaded as an application) comprising computer executable instructions for instructing the one or more microprocessors (e.g., executable data access logic, evaluation logic, and/or information outputting logic). In certain implementations, the one or more microprocessors execute the instructions of the software to provide functionality as described herein.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” “less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. In addition, although the disclosed methods and apparatuses have largely been described in the context of various devices, various implementations described herein can be incorporated in a variety of other suitable devices, methods, and contexts.

Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

What is claimed is:

1. An apparatus comprising:
a plurality of x-ray detection elements configured to receive and detect fluorescence x-rays emitted from a surface of an object being irradiated by an excitation beam, the plurality of x-ray detection elements comprising;
at least a first x-ray detection element configured to receive and detect at least a first portion of the fluorescence x-rays emitted at a first emission angle relative to the surface with a first angular acceptance of less than 30 degrees; and
at least a second x-ray detection element configured to receive and detect at least a second portion of the fluorescence x-rays emitted at a second emission angle relative to the surface with a second angular acceptance less than 30 degrees, the second emission angle larger than the first emission angle by at least 0.5 degree.

2. The apparatus of claim 1, wherein the first emission angle is at least one degree.

3. The apparatus of claim 1, wherein the first emission angle is at least 5 degrees.

4. The apparatus of claim 1, wherein the first angular acceptance and the second angular acceptance are less than 30 degrees.

5. The apparatus of claim 1, wherein the second emission angle is greater than the first emission angle by at least 5 degrees.

6. The apparatus of claim 1, wherein at least one x-ray detection element of the plurality of x-ray detection elements is configured to collect fluorescence x-rays emitted from the surface of the object irradiated by the excitation beam over an acceptance angle perpendicular to the first emission angle or the second emission angle, the acceptance angle greater than 1 degree.

7. The apparatus of claim 1, further comprising a computer system configured to receive detection signals from the plurality of x-ray detection elements and in response at least to the detection signals to generate depth distribution information of one or more atomic elements in the object.

8. The apparatus of claim 1, further comprising at least one Bragg diffractor configured to receive and diffract at least some of the fluorescence x-rays emitted from the object and to direct the diffracted fluorescence x-rays to the plurality of x-ray detection elements.

9. The apparatus of claim 8, wherein the diffracted fluorescence x-rays comprise at least one fluorescence x-ray line that is characteristic of and emitted by at least one atomic element in the object.

10. The apparatus of claim 8, wherein the at least one Bragg diffractor is configured to receive the fluorescence x-rays over an emission angular range ΔΘ of at least 0.5 degree with respect to the surface of the object with emission angles of at least 0.001 degree.

11. The apparatus of claim 8, wherein the at least one Bragg diffractor is selected from the group consisting of: single crystal; mosaic crystal; synthetic multilayer.

12. The apparatus of claim 8, wherein the at least one Bragg diffractor comprises at least one first Bragg diffractor and at least one second Bragg diffractor, the at least one second Bragg diffractor receiving fluorescence x-rays that are transmitted through the at least one first Bragg diffractor.

13. The apparatus of claim 8, further comprising at least one x-ray collimating optic configured to receive and collimate at least some of the fluorescence x-rays and to direct the collimated fluorescence x-rays to impinge the at least one Bragg diffractor.

14. The apparatus of claim 13, wherein the at least one x-ray collimating optic has an angular range of at least 0.5 degree (with respect to the surface of the object with emission angles of at least 0.001 degree.

15. The apparatus of claim 13, wherein the at least one x-ray collimating optic comprises a mirror optic with a reflective surface portion having a paraboloidal shape or a Wolter optic with an infinity image conjugate.

16. The apparatus of claim 13, wherein a beam of collimated fluorescence x-rays emitted from the at least one x-ray collimating optic has an angular divergence of less than 3 degrees.

17. The apparatus of claim 13, wherein the at least one Bragg diffractor comprises a plurality of Bragg diffractors and the at least one x-ray collimating optic comprises a plurality of x-ray collimating optics configured to receive and collimate respective portions of the fluorescence x-rays emitted from the surface and to direct the collimated fluorescence x-rays to corresponding Bragg diffractors of the plurality of Bragg diffractors.

18. An angle resolved wavelength dispersive spectrometer comprising:
at least one Bragg diffractor configured to receive and diffract a first set of fluorescence x-rays characteristic of and emitted by one or more atomic elements in an object, the at least one Bragg diffractor receiving the first set of fluorescence x-rays emitted from the object at an emission angle of at least 0.001 degree from a surface of the object and over an emission angular range of at least 0.5 degree;
a plurality of x-ray detection elements configured to receive and detect at least some of the diffracted x-rays from the at least one Bragg diffractor, the plurality of x-ray detection elements comprising;
at least a first x-ray detection element configured to receive and detect at least a first portion of the fluorescence x-rays diffracted by the at least one Bragg diffractor over a first diffraction angle relative to a surface normal of the at least one Bragg diffractor with a first angular acceptance less than 30 degrees; and
at least a second x-ray detection element configured to receive and detect at least a second portion of the fluorescence x-rays diffracted by the at least one Bragg diffractor over a second diffraction angle relative to the surface normal of the at least one Bragg diffractor with a second angular acceptance less than 30 degrees, the second diffraction angle different from the first diffraction angle by a difference greater than 0.5 degree.

19. The spectrometer of claim 18, wherein the emission angle is at least one degree.

20. The spectrometer of claim 18, wherein the emission angular range is at least 5 degrees.

21. The spectrometer of claim 18, wherein the first angular acceptance and the second angular acceptance are less than 10 degrees.

22. The spectrometer of claim 18, wherein the difference is greater than 5 degrees.

23. The spectrometer of claim 18, further comprising circuitry configured to receive detection signals from the plurality of x-ray detection elements and in response at least to the detection signals to generate depth distribution information of the one or more atomic elements in the object.

24. The spectrometer of claim 18, further comprising at least one second Bragg diffractor configured to receive and diffract a second set of fluorescence x-rays characteristic of and emitted by the one or more atomic elements in the object, the at least one second Bragg diffractor receiving the second set of fluorescence x-rays emitted from the object at an emission angle of at least 0.001 degree from the surface of the object and over an emission angular range of at least 0.5 degree.

25. The spectrometer of claim 24, wherein the plurality of x-ray detection elements are configured to receive and detect at least some of the diffracted x-rays from the at least one second Bragg diffractor.
